(19) United States
(12) Patent Application Publication
(10) Pub. No.: US 2015/0128807 A1
(43) Pub. Date: May 14, 2015

(54) Synthetic Injected Hydrophilic Filter System

(71) Applicant: Dexwet International AG, Vienna (AT)

(72) Inventor: Erich J. Peteln, Blumau (AT)

(73) Assignee: Dexwet International AG, Vienna (AT)

(21) Appl. No.: 14/537,001

(22) Filed: Nov. 10, 2014

Related U.S. Application Data
(60) Provisional application No. 61/903,549, filed on Nov. 13, 2013.

(51) Int. Cl. B01D 46/00; B01D 46/24

(52) U.S. Cl. CPC B01D 46/0035; B01D 46/002; B01D 46/0028; B01D 46/2403
USPC 96/226; 55/484; 55/282; 55/524; 427/299

(57) ABSTRACT

A filter system and method of making same is disclosed. The system includes one or more of filter units, each having a plurality of spaced apart hydrophilic filter tubes coated with an attractant that entrains particulates without the need for woven filter material. The filter tubes may have a plurality of apertures therethrough to increase the surface area of the filter tubes. The filter units may be placed adjacent to each other but with their filter tubes laterally offset to increase the likelihood that particles will engage at least one coated tube.

### CROSS-REFERENCE TO RELATED APPLICATIONS

This application claims priority to U.S. Provisional Patent Application No. 61/903,549 filed on Nov. 13, 2013, the disclosure of which is incorporated herein in its entirety.

### BACKGROUND

This application generally relates to a system, apparatus, and method for removing particulates from an airflow using a filter module. Various machines spanning a variety of industries, e.g., computers, radiators, etc., often include airflow that passes into, through, and/or out of the machines. The airflow often contains particulates that are either generated by the machine or enter the airflow from the machine's surrounding environment. These particulates may impair the machine's functionality, and so it is therefore beneficial to remove the particulates from the airflow using a filter module.

By making the modules removable, replacement becomes quicker and easier. U.S. Pat. No. 8,343,247 (which is incorporated by reference) shows a filter housing with an intake opening and an outlet opening for channelling machine exhaust through, at least one mounting element for mounting the filter module on a machine, and a filter assembly arranged in the filter housing and comprised of at least two filter groups, arranged in tandem in the direction of flow and comprised of rod-shaped filter elements with a filter medium, said elements being arranged parallel to one another at a constant center-to-center distance and with their longitudinal axis largely crosswise to the direction of flow, wherein the filter elements of two adjacent filter groups are parallel to one another, and are arranged offset in relation to one another, crosswise to their longitudinal axes and to the direction of flow.

From U.S. Pat. No. 6,726,749 (which is incorporated by reference), a filter device of this type designed for removing air-polluting materials from the exhaust air from machines, especially office machines, is known. This device has a plurality of filter sticks in a filter housing, which sticks are supplied with fluid from a fluid container, and a fastening device for mounting the filter housing on a machine, wherein the filter rods are positioned in the exhaust air flow. As can be seen in FIG. 7 of U.S. Pat. No. 6,726,749, in one embodiment the filter rods are arranged in rows, and the rows are offset in relation to one another. The air-polluting materials are absorbed as they pass by the filter rods wetted with the fluid, and are thereby removed from the exhaust air flow.

One disadvantage of these systems is that the filter rods are difficult and expensive to manufacturer and that maintenance or replacement of the filter rods is correspondingly laborious and tedious. Also disadvantageous is that the fluid is consumed when the filter device is in use, and the fluid container must be regularly refilled to extend its useful period, to maintain the wetting of the filter rods. This filling process requires a great deal of caution or additional accessories to prevent contamination. Independent of the need to repeatedly supply the filter with fluid, if the filter rods are badly soiled following an extended period of use or due to severely polluted machine exhaust, a reconditioning cleaning or replacement of the filter rods or of the entire filter device may be necessary, which, because of the individually attached filter rods, entails high costs from increased handling expenses or a complete replacement.

Further, the use of woven filter materials has proven to be disadvantageous in that they are difficult or impossible to clean and reuse and become clogged relatively quickly. The present disclosure provides a filter device that is cheaper to manufacture, use and replace.

### SUMMARY

The following summary is intended to assist the reader in understanding the full disclosure and the claims. The claims define the scope of the invention, not this summary.

According to an aspect of one or more exemplary embodiments, there is provided a filter system for removing particulates from a flow of air in a variety of applications, including machine exhaust, filtering air flow in a room using a radiator, and internal machine air flow in, for example, slot machines, automatic teller machines (ATMs), and automobiles. The filter system may include at least first and second parallel filter units disposed adjacent each other, each such filter units having a longitudinal axis and a plurality of spaced-apart filter tubes defining a gap there between. The filter units may be laterally offset relative to each other so that the gaps in said first unit are adjacent filter tubes in said second unit. The filter tubes may be formed of a hydrophilic material capable of retaining a liquid attractant, and may be covered at least in part, by an attractant formulated to entrain particulates. The filter tubes may include a plurality of apertures over its surfaces to thereby increase the surface area available for coverage by said attractant.

Alternatively, the system has only one unit or even one tube. In addition, the apertures of the filter tubes may be rectangular and/or the filter tubes may be cylindrical. The first and second units may be joined together to form an array. The entire filter system may be a unitary element formed from a single shot injection, using, for example and without limitation, a synthetic material such as Polyamide 6 (“PA6”) or similar, by injection molding. Producing the components of the filter unit using a plastic injection molding process may be economical especially when large piece numbers are required, and may achieve consistently high work piece precision levels and quality. In selecting the plastic to be used, the temperature of the exhaust air may be taken into account so that during use, no impermissible shape changes in the components of the filter module occur as a result of the exhaust air temperatures.

The filter tubes of the filter system may be hollow and include a magnetic strip element. The filter tubes may be hollow and include a connection for providing a vacuum to at least some of the tubes to withdraw air therefrom. The filter tubes may be hollow and include a connection for providing a positive air flow to at least some of the tubes to purge tubes of particulates and clear the apertures. A surface area of the filter tubes in a plane perpendicular to the direction of flow may have a larger surface area than the free passage surface area between the filter tubes in a plane perpendicular to the direction of flow of air.

The attractant may be a fluid selected from the group consisting of glycerin, silicone oil, essential oil, paraffin oil, and latex emulsion. The attractant may also include a substance selected from the group consisting of an antibacterial, antiviral, antimycotic, and fungicidal substance. The attractant does not require any fluid container, and may have a molecular structure that allows the attractant to resist drying out for substantial periods of time. The filter tube may also include a surface treatment selected from the group consisting of an antibacterial, antiviral, antimycotic and fungicidal surface. One or more of the filter tubes may have a cross-sectional shape selected from the group consisting of rectangle, square, triangle, circle, star and oval.

The filter system may also include a connector disposed on one of the first and second filter units and a receiver on the other of the first and second filter units for connecting the filter units. For example, the connector and receiver may include magnets that connect the first and second filter units. The magnets may also connect the first and second filter units to a machine or radiator for performing filtering. The magnets may also be used to connect the first and second filter units in various configurations to accommodate various lengths and sizes.

According to another aspect of one or more exemplary embodiments, there is provided a method of making an air filter devoid of woven filter material comprising any or all of the following steps, in any order:
(a) forming a first filter unit using one or more hydrophilic materials, such that the first filter unit includes a plurality of tubes that may have a plurality of apertures on the surface of said tubes, said tubes being formed in a side-by-side, generally parallel relationship with gaps between said tubes;
(b) forming a second filter unit using one or more hydrophilic materials, such that the second filter unit includes a plurality of tubes that may have a plurality of apertures on the surface of said tubes, said tubes being formed in a side by side generally parallel relationship with gaps between said tubes;
(c) disposing the first and second filter units adjacent to each other with said tubes offset between units so that a tube in the first unit is adjacent a gap in the second unit
(d) coating at least a portion of said tubes in a liquid particulate attractant, said attractant having an affinity to said hydrophilic materials.

The method may also include periodically applying a vacuum to ends of at least some of said tubes to attract particulates thereto via said apertures. The method may also include periodically applying a positive pressure to ends of at least some of said tubes to purge particulates from said apertures.

According to yet another aspect of one or more exemplary embodiments, there is provided a filtration tube that may include a hollow tube that may have a plurality of apertures therethrough to increase its surface area; the tube being formed to have a hydrophilic surface to receive and retain an attractant fluid. The tube may also be covered at least in part, by an attractant fluid capable of entraining particulates.

### BRIEF DESCRIPTION OF THE DRAWINGS

FIG. 1 is a front perspective view of a filter unit having a plurality of filter tubes, according to an exemplary embodiment.

FIG. 2 is front plan view of one face of the filter unit, according to an exemplary embodiment.

FIG. 3 is a top plan schematic view of the filter unit, according to an exemplary embodiment.

FIG. 4 is a close up rear perspective view with portions broken away, according to an exemplary embodiment.

FIG. 5 is a close up front perspective view with portions broken away, according to an exemplary embodiment.

FIG. 6 is a side perspective view of the rear face and end of a filter unit, according to an exemplary embodiment.

FIG. 7 is a front elevated perspective view of a pair of filter units joined together, according to an exemplary embodiment.

### DETAILED DESCRIPTION OF EXEMPLARY EMBODIMENTS

By way of introduction, it is noted that in the differently described embodiments, equivalent parts are designated by the same reference symbols or component descriptions, wherein the disclosures contained in the entire description can be logically transferred to equivalent parts having the same reference symbols or the same component descriptions. Also, positional information selected in the description, such as above, below, to the side, etc., refers to the immediately described or illustrated figure, and, in the case of a position change, can be logically transferred to the new position. Furthermore, individual characterizing features or combinations of features from the illustrated and described exemplary embodiments can also represent solutions that are independent, inventive or specified in the inventive concepts.

The filtration system according to one or more of the exemplary embodiments described herein may be used for many environments, most particularly, office machines, computer displays, or the like which either generate particulates or are in dirty environments. The following additional areas of application of the filter module of the exemplary embodiments are listed as examples of the multitude of potential applications: installation in or on the outlet of exhaust pipes or chimneys, use as a back-up filter or supplementary filter for vacuum cleaners, use in motor vehicles, for example as a supplementary air filter or as a filter for the air in the interior of the vehicle, for example as a pollen filter, as an industrial filter in power plants, filters for indoor air systems, such as air conditioners or ventilation systems. Express reference is made in this connection to the possible use as a filter for supplied air, ambient air, or intake air for the widest range of machine types.

Exemplary embodiments will now be described with reference to the attached drawings. It is understood that the filter unit may be used with a ventilator/fan (not shown in Figures) which will draw air through the filter unit, however the filter unit does not require a fan or ventilator. In addition, the mounting units, which mount the filter unit to the machine producing the exhaust, are not described herein but can be any mounting mechanism known in the art or by those described in the patents discussed above.

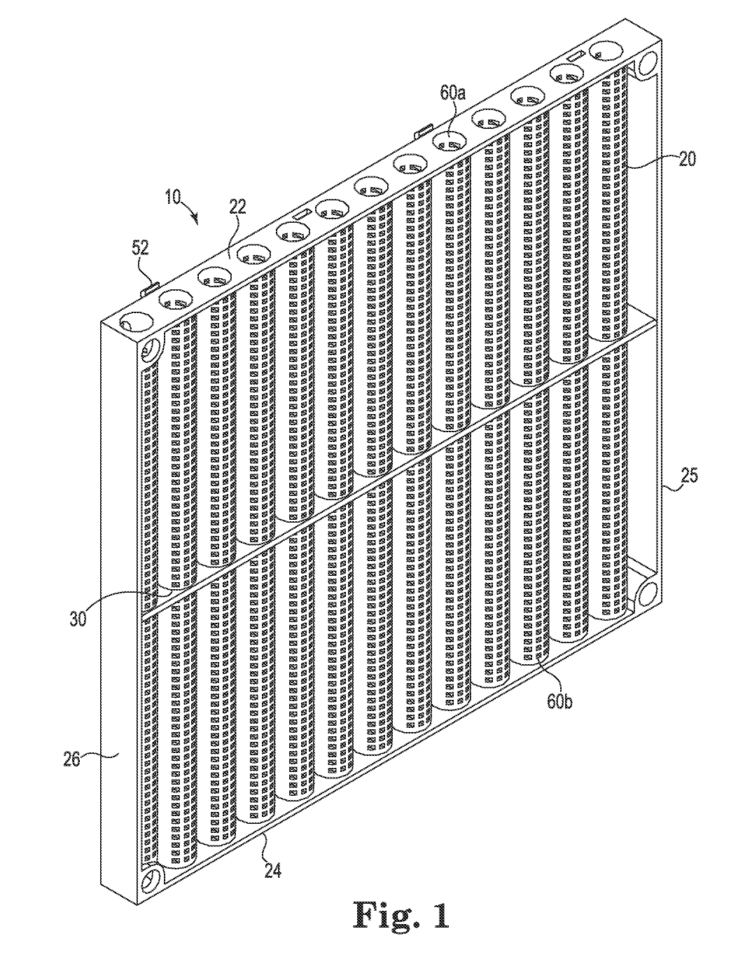

FIG. 1 is a front perspective view of a filter unit according to an exemplary embodiment. Referring to FIG. 1, filter unit 10 includes a top plate 22 and a bottom plate 24, two side plates 25 and 26, and a plurality of filter tubes 20 which are disposed between top plate 22 and bottom plate 24. Filter tubes 20 each may have open ends 60a and 60b at opposite ends of the filter tube 20. Filter unit 10 may also include a junction clip 52 that is used to connect filter unit 10 to other filter units, as will described below. Filter unit 10 may also include intermediary cross member 30. Filter tubes 20 may pass through or be supported by intermediary cross member 30. Filter unit 10 may be produced as a single injection molded unit with filter tubes 20, top and bottom walls 22, 24, sidewalls 25, 26, and optionally middle support 30 formed in a single shot. This creates a unitary device in one step.

Filter tubes 20 may be formed of a substantially rigid material so that the filter tubes 20 themselves are self-supporting. In addition, filter tubes 20 may be constructed using a non-woven material that may not independently filter air, but that does filter air in combination with an attractant that is applied to the filter tubes 20, as will be discussed below. The filter tubes 20 may be constructed of non-absorbent, PA6 or similar material, but the filter tube 20 according to an exemplary embodiment does not absorb any liquid, including the attractant discussed further below. This makes it possible to clean the tube by washing and recoating with attractant. More specifically, filter unit 10 may be formed using PA6 made by many companies such as BASF®. One version, Polyamide B: PA 6 (unreinforced) from BASF® is quoted as a tough and strong material affording parts with good damping characteristics and high shock resistance even in the dry state and at low temperatures. Ultramid PA6 is distinguished by particularly high impact resistance and ease of processing. The characteristic of PA6 which is of particular interest to the present disclosure is that it is hydrophilic with respect to oil so that it will attract and retain oil without simply miming off. Other materials with hydrophilic properties may also be used in the filter unit according to the exemplary embodiment.

The filter tubes 20 may be covered in an oil or other attractant or wetting agent selected from the group of fluids such as glycerin, silicone oil, essential oil, paraffin oil, and/or latex emulsion. According to an exemplary embodiment, the attractant may be a silicone oil type AK 2000 from Wacker Chemie AG, but such an attractant is merely exemplary and can be replaced by other attractants. The air-polluting materials in the machine exhaust, such as dust, fine dust, ultrafine particles pollen, spores, bacteria, other aerosols with solid or liquid particles, and in the case of an office machine especially toner dust and/or paper wear debris, can be effectively bonded mechanically when they come in contact with the wetted filter medium. Gaseous pollutants, such as ozone, benzole, phenol, carbon dioxide, formaldehyde or unpleasant odors can also be chemically absorbed and/or neutralized by coming into contact with the fluid. Further, according to another exemplary embodiment of the filter unit, it may be advantageous to equip the filter unit with an antibacterial surface. This can be accomplished, for example, with a coating or impregnation with silver, especially nanoscale silver, or a silver compound. Moreover, to remove ferromagnetic particles, such as iron wear debris, from the machine, one or more exemplary embodiments provide that one or more filter units may be equipped with a magnetic element or a magnetic component, which may be a permanent magnet or an electromagnet.

The filter unit according to an exemplary embodiment may result in low vapor pressure and correspondingly low evaporation rate, which produces a long service life. The viscosity of these fluids is further favorable to an even distribution in the filter tube via the capillary and hydrophilic effect that occurs with the wetting of the filter tube. With a correspondingly adjusted high level of viscosity and surface tension, a direct wetting of the filter tube is also possible, whereby a filter medium is effectively formed by the fluid on the tube.

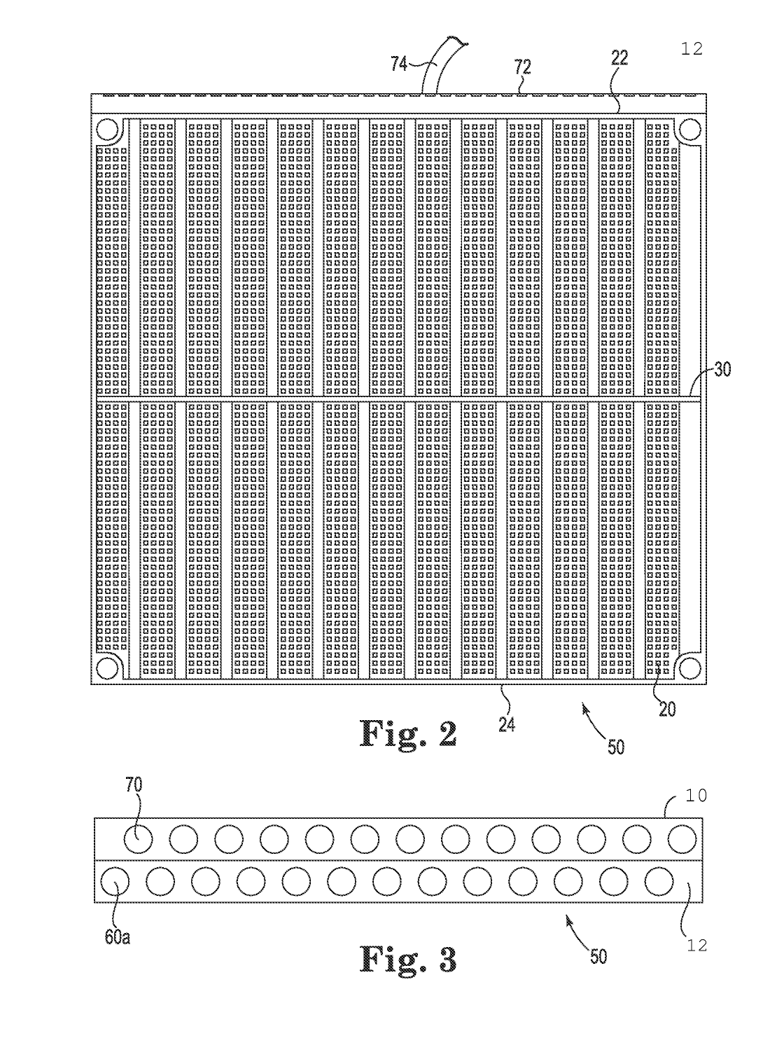

FIG. 2 is front plan view of one face of a filter unit according to an exemplary embodiment. FIG. 3 is a top plan schematic view of the filter unit, according to an exemplary embodiment. Referring to FIGS. 2 and 3, the filter unit according to the exemplary embodiment may include first filtering unit 10 and second filtering unit 12 disposed directly adjacent to each other. The exhaust air is filtered through the filter units 10 and 12 with each filter unit including multiple rod-shaped filter tubes 20, which are arranged with their longitudinal axes largely perpendicular to the direction of air flow 50, and which may be parallel to one another at a consistent center-to-center distance. The filter tubes 20 of the two adjacent filter units 10, 12 may also be parallel to one another. Filter tubes 20 may be connected at their open ends 60a, 60b to a source of air or vacuum 74 by direct connection to the tube ends or by a manifold 72 and a single connection to each filter tube 20. Connecting a vacuum to the filter tubes may help draw particulates to the tubes to further enhance filtering.

The individual filter tubes 20 may be cylindrically shaped with a round cross-section. As an alternative to this cylindrical configuration, other shapes such as square, triangular, star-shaped, circular, or oval cross-sections, are also possible. The rectangular, triangular or round, especially circular, embodiment of the filter elements may be easier to produce in terms of manufacturing technology. In addition, the rectangular and circular cylindrical forms may favor a symmetrical configuration of the filter inserts. The star-shaped cross-section, in contrast, offers a high value in the ratio of surface to volume of the filter element, allowing a large filter surface to be accommodated in a relatively small space. The cross-sectional shape can also be used to influence the flow of exhaust air through the filter units, for example to eddy the flow through cross-sections that are unfavorable to flow, such as rectangular cross-sections, and to intensify contact of the exhaust air with the filter tubes. The cross-sectional shape may be used to calm the flow through cross-sections that are favorable to flow, such as triangular cross-sections, if the exhaust air flow from the machine is strong and turbulent and therefore potentially disruptive.

According to the exemplary embodiment shown in FIGS. 2 and 3, the filter tubes 20 from two filter units 10, 12 are not arranged in tandem in a straight line viewed in the direction of air flow 50, but are offset, parallel to one another, perpendicular to the direction of air flow 50. In the exemplary embodiment shown in FIG. 3, two structurally uniform filter units 10, 12 are arranged offset in relation to one another by half the center-to-center distance, whereby tubes are situated in tandem are also offset in relation to one another, and in each case, a filter tube 20 of filter unit 10 is centered behind a gap formed by two adjacent filter tubes 20 of adjacent filter unit 12. If the width of the filter tubes 20 is greater than half the center-to-center distance, as in the illustrated example, it is essentially impossible for particulates to pass through the filter array in a straight line, which forces a sharp redirection of the exhaust air flowing through, thereby increasing the filtering effect. According to an exemplary embodiment, the center-to-center spacing may not be uniform, and the width of the tube may not be greater than half of the center-to-center distance.

With further reference to FIGS. 2 and 3, to attract ferrous metal particulates, a magnetic strip 70 may be located within the filter tubes 20, or the tubes themselves may be a constructed using a magnetic material that is coated with a hydrophilic material. The filter tubes 20 may have a surface area in a plane perpendicular to the direction of flow which has a larger surface area than the free passage surface area between the filter tubes in a plane perpendicular to the direction of flow of air.

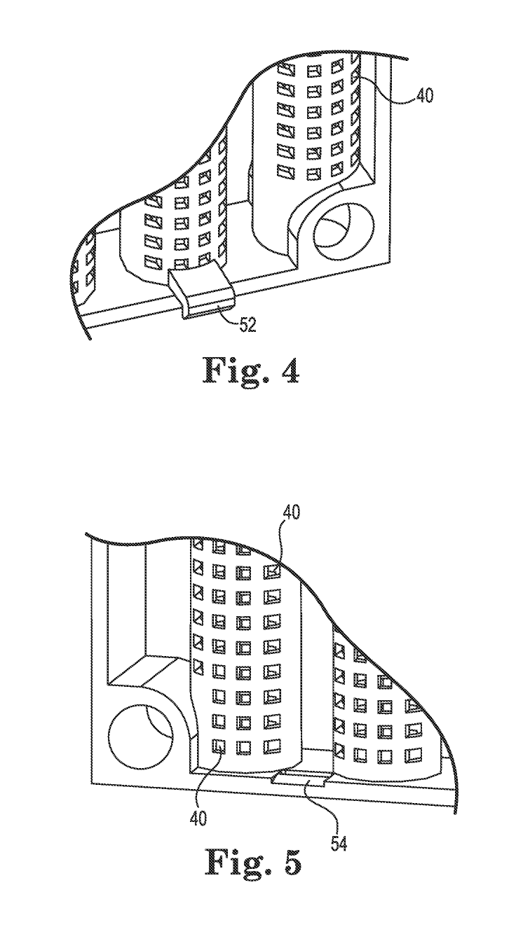

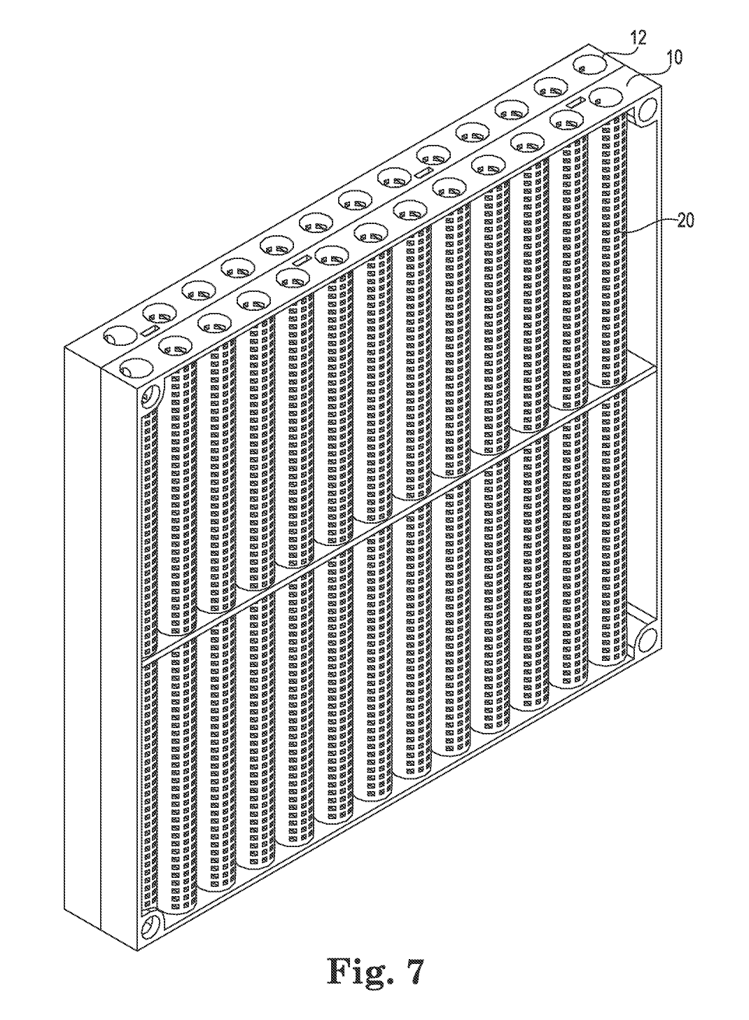

FIG. 4 is a close up rear perspective view with portions broken away of a filtering unit according to an exemplary embodiment. FIG. 5 is a close up front perspective view with portions broken away of a filtering unit according to an exemplary embodiment. Referring to FIGS. 4 and 5, the filter unit according to an exemplary embodiment may include junction clips 52 and like engagement recesses 54 so that two, three or more units can be joined back to back as shown in FIGS. 3 and 7. In addition, the filter unit may include filter tubes 20 having a tubular shape, but the filter tubes 20 may also be oval, multi-sided, or other shape. Each filter tube 20 may also include a plurality of small apertures 40 which increase the effective surface area of the filter tube 20 substantially and provide a passage for air.

The apertures 40 may be rectangular or square, but may be other shapes including round, oval or irregular to increase the surface area further. For example, and without limitation, for a filter unit having dimensions of 15 cm×15 cm, aperture 40 may be approximately 0.1 mm to 0.5 mm (and any increment thereof in 0.01 mm) in diameter or diagonal measurement.

In the filter unit according to an exemplary embodiment, the attractant (the word oil will be used as a generic term for all possible attractants) combined with the hydrophilic properties of the tube material become the filter medium without the need for woven material. By dramatically increasing the surface area of the tube, by creating apertures, the filter media for a single tube is substantially greater than the mere tube without apertures. Thus the loading capacity of the tube is also substantially greater. In addition, when a vacuum is connected to the filter tubes, as shown in FIG. 2, particulates are drawn to the filter tubes 20 by lowering the pressure therein at the apertures 40. The withdrawn air can be recirculated or expelled.

As particulates pass through the apertures 40, they become entrapped by the oil/attractant as they are required to make the directional turn up the hollow filter tube 20. As the filter tubes 20 become loaded with particulates or the apertures 40 become blocked, the amount of filtration will eventually reach a level which is too low to be effective. At that point, a pressure differential tester that measures pressure from front to back of the filter unit(s) will reach a predetermined level indicating that the filter should be changed, cleaned or purged. Because the filter media is an attractant, it can be removed by washing the unit in a detergent and the unit can be re-oiled. As a result of the construction employed in the exemplary embodiments, it is possible to entrain substantial amounts of particulates without the need for woven filter materials. In addition, a pulse-width modulation (PWM) fan may be used to purge the filter unit of particulates. If the filter unit becomes overly saturated with particulates, the speed of the PWM fan may be increased in order to purge the particulates. The saturation level may be monitored so that the speed of the PWM fan may be decreased once the particulate level has reached an acceptable level.

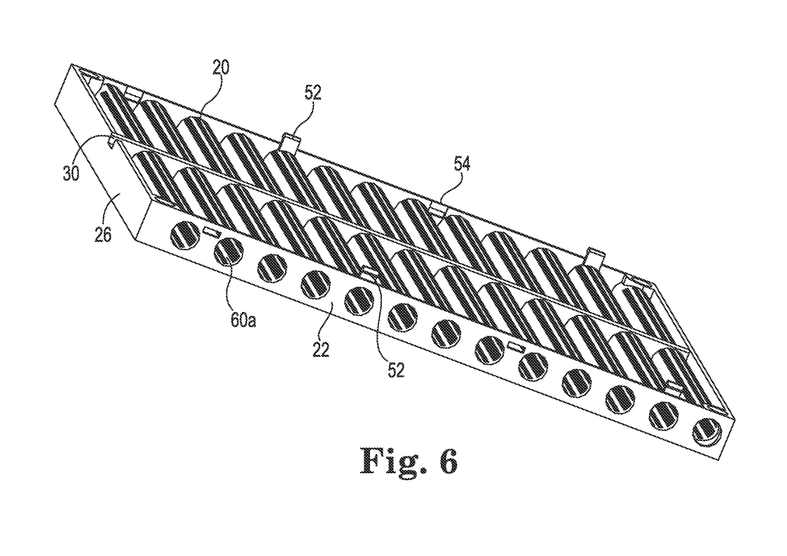

FIG. 6 is a side perspective view of the rear face and end, of a filter unit, according to an exemplary embodiment. Referring to FIG. 6, the filter unit according to the exemplary embodiment may have various shapes. For example, the filter unit may be rectangular with the length of the top plate 22 substantially greater than the length of side plate 26. By contrast, the filter unit shown in FIG. 1 includes top plate 22, bottom plate 24, and side plates 25, 26 that are roughly equivalent in size. As also shown in FIG. 6, the filter unit may include multiple junction clips 52 and engagement recesses 54 to facilitate joining multiple filter units together to form a filter array.

FIG. 7 is a front elevated perspective view of a pair of filter units joined together, according to an exemplary embodiment. Referring to FIG. 7, two filter units 10, 12 may be configured back to back. Filter tubes 20 of first filter unit 10 may be laterally offset with respect to filter tubes 20 of second filter unit 12 so as to increase the likelihood that air engages at least one of the units. In this configuration, gaps between the filter tubes 20 in the first filter unit 10 are blocked by filter tubes 20 of the second filter unit 12 when viewed in the direction in which air would flow through the filter. Since particulates are heavier than air, they are less likely to be able to make the required arc between adjacent tubes in the two units and are likely to engage one of the tubes by centrifugal force.

According to a further exemplary embodiment, it may also be advantageous to orient the longitudinal axes of the tubes to the direction of flow, in order to create large active surfaces and a sharp redirection of the exhaust air. With this arrangement of the filter elements, the filter module can be configured to be short, viewed in the direction of flow, with multiple filter inserts in tandem.

According to an alternative exemplary embodiment, a reverse flow of purging air can be introduced into the tubes to clear particulates out of the holes. This is preferably done when the ventilator/air flow device is turned off so that particulates have an opportunity to be entrained on other parts of the unit which are also covered in oil, or if the unit is sitting in a reservoir of oil, or the base frame of the unit is covered in oil, the particulates will merely fall down to such oiled surface and be entrained when the ventilator is restarted.

In addition to the filter unit described above, the disclosure also provides a method of manufacturing a filtration unit according to an exemplary embodiment that may include molding a plurality of adjacent hydrophilic tubes into an array of tubes that area adjacent but spaced apart from each other, covering the tubes with an attractant, and passing exhaust air through the tube array so that air encounters the tubes.

The method according to the exemplary embodiment may also include making an air filter devoid of woven filter material with one or more of the following:
(a) forming a filter unit having a plurality of porous tubes using hydrophilic materials, wherein the tubes being formed in a side by side generally parallel relationship with gaps between the tubes;
(b) forming a second filter unit having a plurality of porous tubes using hydrophilic materials, wherein the tubes are formed in a side by side generally parallel relationship with gaps between the tubes;
(c) disposing the filter units adjacent to each other with said tubes offset between units so that a tube in the first unit is adjacent a gap between tubes in the second unit;
(d) coating at least a portion of the tubes in a liquid particulate attractant, wherein the attractant has an affinity to the hydrophilic materials.

To increase efficiency, the method may include disposing a plurality of tube arrays/units back-to-back but offset so that spaces between tubes in one unit are adjacent tubes in the adjacent unit so that exhaust air is more likely to engage one or more tubes when traveling orthogonally to the length of the tube.

To further increase efficiency, the method may include forming a plurality of holes in each tube to increase the surface area which can receive the attractant. To even further increase efficiency, the method may include applying a vacuum to the end of the tubes to draw particulates to the holes. Also to further increase efficiency, the method may include periodically providing a positive pressure flow into the ends of the tubes to purge the holes of particulates, particularly when the ventilator is not running so that particulates may be entrained on other surfaces in the gravitational path where further attractant is located.

The description of the exemplary embodiments and its applications as set forth herein is illustrative and is not intended to limit the scope of the claims. Variations and modifications of the exemplary embodiments disclosed herein are possible and practical alternatives to and equivalents of the various elements of the exemplary embodiments would be understood to those of ordinary skill in the art upon study of this patent document. These and other variations and modifications of the exemplary embodiments disclosed herein may be made without departing from the scope and spirit of the inventive concept.

What is claimed is:

1. A filter system for removing particulates from a flow of an air exhaust system comprising:
a first filter unit comprising a first plurality of filter tubes having a first longitudinal axis, wherein the filter tubes of the first plurality of filter tubes are spaced to create one or more gaps between the filter tubes of the first plurality of filter tubes;
wherein at least one of the filter tubes of the first plurality of filter tubes is formed of a hydrophilic material capable of retaining a liquid attractant; and
wherein the first plurality of filter tubes is covered at least in part by an attractant formulated to entrain particulates.

2. The filter system according to claim 1, further comprising:
a second filter unit comprising a second plurality of filter tubes having a second longitudinal axis, wherein the filter tubes of the second plurality of filter tubes are spaced to create one or more gaps between the filter tubes of the second plurality of filter tubes;
wherein the second filter unit is disposed adjacent to the first filter unit; and
wherein the first plurality of filter tubes are laterally offset with respect to the second plurality of filter tubes such that at least one gap between filter tubes in the first plurality of filter tubes is adjacent to a filter tube of the second plurality of filter tubes.

3. The filter system according to claim 1, wherein the at least one of the first plurality of filter tubes comprises a plurality of apertures on its surface to thereby increase the surface area available for coverage by the attractant.

4. The filter system according to claim 3, wherein the apertures are rectangular.

5. The filter system according to claim 3, wherein the filter tubes are cylindrical.

6. The filter system according to claim 2, wherein the first and second filter units are joined together to form a filter array.

7. The filter system of claim 1, wherein the entire filter system is a unitary element formed from a single shot injection.

8. The filter system of claim 1, wherein at least one of the first plurality of filter tubes is hollow and includes a magnetic strip element.

9. The filter system of claim 1, wherein at least one of the first plurality of filter tubes is hollow and includes a connection for providing a vacuum to withdraw air therefrom.

10. The filter system of claim 1, wherein at least one of the first plurality of filter tubes is hollow and includes a connection for providing a positive air flow to at least one of the first plurality of filter tubes to purge the at least one filter tube of particulates.

11. The filter system according to claim 1, wherein a surface area of one filter tube of the first plurality of filter tubes in a plane perpendicular to a direction of airflow through the filter unit is greater than a surface area of a gap between two filter tubes of the first plurality of filter tubes in a plane perpendicular to the direction of airflow through the filter.

12. The filter system according to claim 1, wherein the attractant comprises fluid selected from the group consisting of glycerin, silicone oil, essential oil, paraffin oil and latex emulsion.

13. The filter system according to claim 1, wherein the attractant comprises a substance selected from the group consisting of an antibacterial, antiviral, antimycotic, and fungicidal substance.

14. The filter system according to claim 1, wherein at least one of the first plurality of filter tubes comprises a surface treatment selected from the group consisting of an antibacterial, antiviral, antimycotic, and fungicidal surface.

15. The filter system according to claim 1, wherein at least one of the first plurality of filter tubes has a cross-sectional shape selected from the group consisting of rectangle, square, triangle, circle, star, and oval.

16. The filter system according to claim 2, further comprising:
a connector disposed on the first filter unit; and
a receiver disposed on the second filter unit;
wherein the connector and the receiver are configured to interconnect to join the first filter unit and the second filter unit.

17. The filter system of claim 1, wherein at least one of the first plurality of filter tubes is formed of a substantially rigid non-absorbent material.

18. The filter system of claim 1, wherein at least one of the first plurality of filter tubes is made of a non-woven material.

19. The filter system of claim 2, wherein said first and second pluralities of filter tubes are laterally offset relative to each other so that gaps between the filter tubes of the first plurality of filter tubes are blocked by filter tubes of the second plurality of filter tubes when viewed in a direction in which air flows through the filter system.

20. A method of making an air filter system, the method comprising:
forming a first filter unit using a hydrophilic material, said first filter unit comprising of a first plurality of filter tubes configured in a side-by-side, generally parallel relationship with gaps between said filter tubes of said first plurality of filter tubes; and
coating at least a portion of said first plurality of filter tubes in a liquid particulate attractant, said attractant having an affinity to said hydrophilic material;
wherein said hydrophilic material is capable of retaining said liquid particulate attractant.

21. The method of claim 20, further comprising:
forming a second filter unit using a hydrophilic material, said second filter unit comprising a second plurality of filter tubes configured in a side-by-side, generally parallel relationship with gaps between said filter tubes of said second plurality of filter tubes; and
disposing the second filter unit adjacent to the first filter unit such that the first plurality of filter tubes are laterally offset with respect to the second plurality of filter tubes such that at least one gap between filter tubes in the first plurality of filter tubes is adjacent to a filter tube of the second plurality of filter tubes.

22. The method of claim 20, wherein forming the first filter unit comprises forming a plurality of apertures on a surface of at least one filter tube of the first plurality of filter tubes.

23. The method of claim 22 further comprising applying a vacuum to an end of at least one of the first plurality of filter tubes to attract particulates thereto via said plurality of apertures.

24. The method of claim 22 further comprising applying a positive pressure to an end of at least one of the first plurality of filter tubes to purge particulates from said plurality of apertures.

25. The method of claim 20, wherein at least one of the first plurality of filter tubes is made of a non-woven material.

26. A filtration tube comprising:
a hollow, non-absorbent tube comprising a plurality of apertures therethrough;
wherein, the tube is formed to have a hydrophilic surface to receive and retain an attractant fluid; and
wherein said tube is covered at least in part, by an attractant fluid capable of entraining particulates.
